(19) United States
(12) Patent Application Publication
(10) Pub. No.: US 2010/0280941 A1
(43) Pub. Date: Nov. 4, 2010

(54) METHOD OF MANAGING A CENTRALIZED PARKING PAYMENT SYSTEM, AND CENTRALIZED PARKING PAYMENT SYSTEM

(75) Inventors: Francois MASSON, Serre Les Sapins (FR); Emmanuel CROZE, Charnay (FR)

Correspondence Address: YOUNG & THOMPSON, 209 Madison Street, Suite 500, Alexandria, VA, 22314, US

(73) Assignee: PARKEON, Paris (FR)

(21) Appl. No.: 12/767,926

(22) Filed: Apr. 27, 2010

(30) Foreign Application Priority Data
Apr. 29, 2009 (FR) 0952843

(51) Int. Cl. G06Q 50/00; G06Q 40/00; G06Q 10/00; H01M 10/46; G06F 15/16

(52) U.S. Cl. 705/39; 320/101; 709/217

(57) ABSTRACT

A method of managing a centralized parking payment system (2), the system (2) including at least one pay and display machine (6) and a payment centralization server (4), the or each pay and display machine (6) permitting payment for parking spaces situated in a corresponding payment zone (44) and being capable of creating payment data for the parking spaces and of recording them in a payment transactions file, and each pay and display machine (6) communicating via a first connection (12) with the centralization server (4), is characterized in that it includes a nominal operating mode in which the or each pay and display machine (6) transmits the transaction file only when one of the transmission conditions, apart from the simple creation of payment data, is verified, in order to reduce its energy consumption.

The present invention relates to a method of managing a centralized parking payment system, said system comprising at least one pay and display machine and a payment centralization server, the or each pay and display machine permitting payment for parking spaces situated in a corresponding payment zone and being capable of creating payment data for the parking spaces and of recording said data in a payment transactions file, and each pay and display machine communicating via a first connection with the centralization server.

The invention relates also to a centralized parking payment system, of the type comprising at least one pay and display machine, a payment centralization server and means for exchanging data via a first connection between the centralization server and the or each pay and display machine, the or each pay and display machine comprising means for receiving a payment for parking spaces in a corresponding payment zone, means for creating payment data for the parking spaces, and means for recording said payment data in a payment transactions file.

Parking spaces for a centralized parking payment system are generally identified by an alpha-numerical identifier marked on the ground. When a user parks his motor vehicle in a free parking space, he notes the identifier of the space where he has parked his vehicle and then makes his way to a neighbouring pay and display machine. He then pays the amount corresponding to the desired parking time, specifying the identifier of the space in which his vehicle is parked. The user does not then need to return to his vehicle in order to display his proof of payment.

Monitoring of parking payments is carried out by verifying that there is a valid payment transaction for each space identifier occupied by a vehicle.

In a data exchange method of the prior art, when a payment transaction is carried out at a pay and display machine, the data of the transaction are immediately transmitted to the server by the pay and display machine. Each pay and display machine also periodically sends a reporting message to the centralization server in order to indicate that it is still operational. The data exchange method of the prior art makes it possible to know, at any time, which pay and display machines are operational and to ensure that the information necessary for monitoring the payment of parking fees is always available from the server.

However, such a process has the disadvantage that a large amount of energy is consumed for each pay and display machine.

The object of the invention is, therefore, to reduce the energy consumption for each pay and display machine while ensuring that the information necessary for monitoring the payment of parking fees is always available.

To that end, the invention relates to a management method of the above-mentioned type, characterized in that it comprises a nominal operating mode in which the or each pay and display machine transmits the transaction file only when one of the transmission conditions, apart from the simple creation of payment data, is verified, in order to reduce its energy consumption, and in that, in nominal operating mode, the ratio between the number of transaction files transmitted and the number of payment transactions is strictly less than 1.

According to other embodiments, the method has one or more of the following features, taken in isolation or in any technically possible combinations:
exchanges of transaction files between the or each pay and display machine and the centralization server are at least partially aperiodic,
the transmission conditions include the receipt of a request from the centralization server,
the or each pay and display machine is always in either nominal mode or a parking fee payment monitoring mode, said monitoring mode being activated upon a request from an operator, and, in monitoring mode, the transaction file is transmitted to the centralization server in dependence on the creation of payment data,
the method comprises steps in which:
   an operator formulates a request for monitoring of the payment of parking fees in a monitoring zone,
   each pay and display machine that is located in the monitoring zone and has received the monitoring request from the centralization server sends its transaction file to the centralization server,
   on a command from the centralization server, each pay and display machine that has transmitted its transaction file passes into monitoring mode,
the transmission conditions include secondary conditions which are as follows:
   the pay and display machine is connected to a server external to the payment system,
   the pay and display machine receives a payment transaction for a space outside its payment zone, and
   at least one payment transaction has been contained in the transaction file for a time that exceeds a predetermined time.

The invention relates also to a centralized parking payment system of the above-mentioned type, characterized in that the or each pay and display machine is capable of transmitting a message only when one of the transmission conditions, apart from the simple creation of payment data, is verified, in order to reduce its energy consumption, and in that, in nominal operating mode, the ratio between the number of transaction files transmitted and the number of payment transactions is strictly less than 1.

According to other embodiments, the system has one or more of the following features, taken in isolation or in any technically possible combinations:
each pay and display machine is supplied with power by an autonomous battery,
each pay and display machine comprises means for recharging the autonomous battery by solar energy,
each pay and display machine is capable of communicating with an external server via the first connection and the centralization server, said external server preferably being a banking server,
the system comprises a portable computer which is used by an operator and communicates with the centralization server via a second connection.

The invention and its advantages will be better understood upon reading the following description, which is given solely by way of example and with reference to the accompanying drawings, in which:

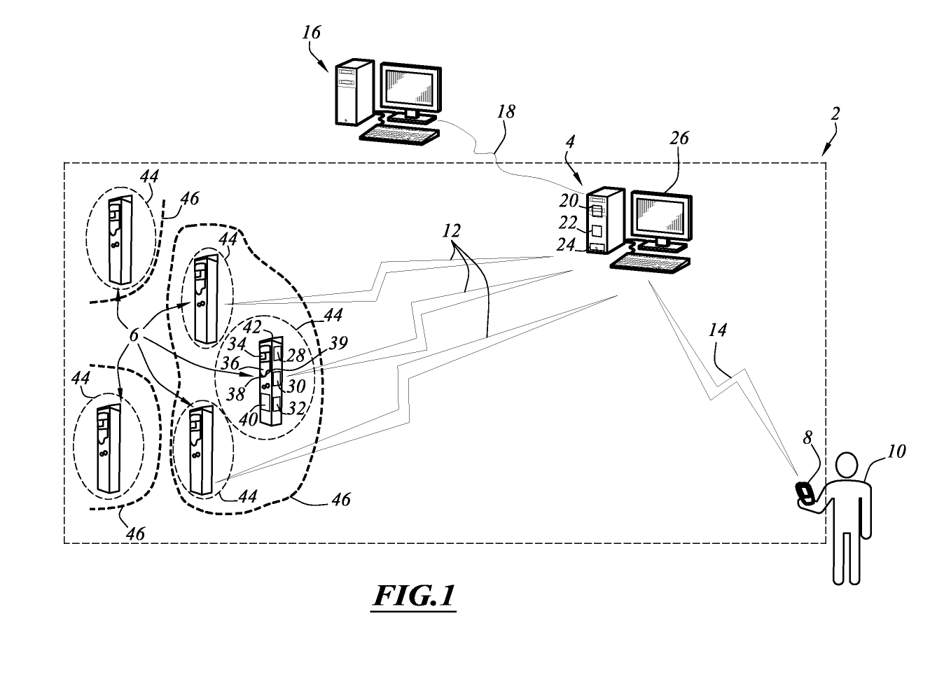

FIG. 1 is a diagrammatic representation of a centralized parking payment system according to the invention,

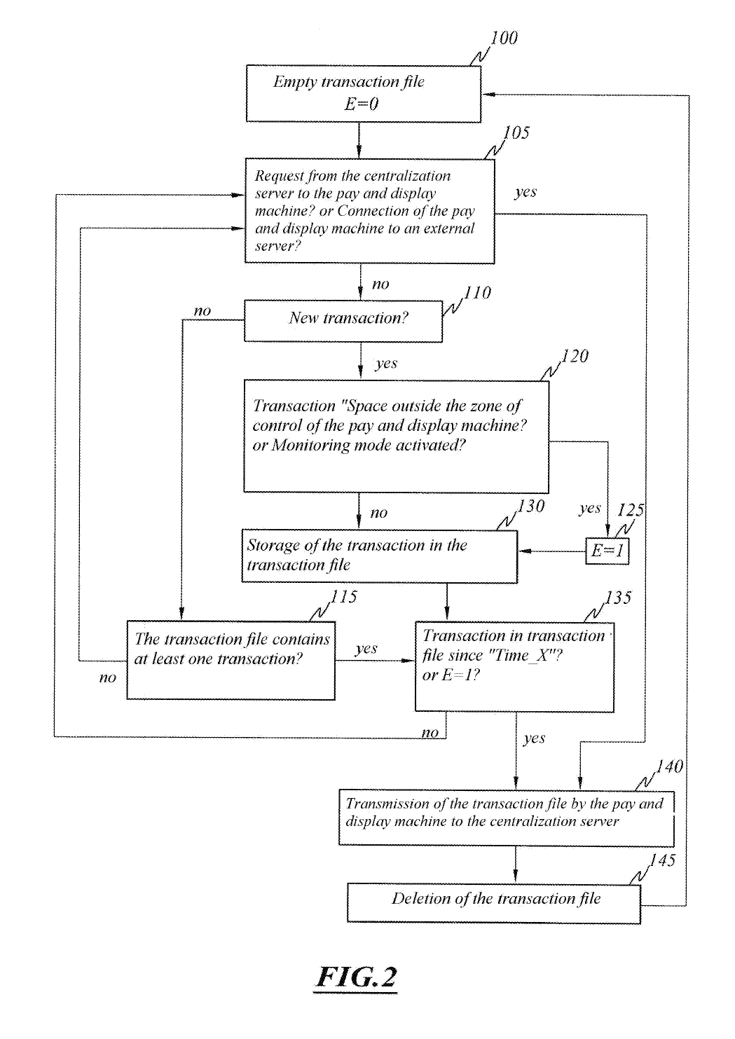

FIG. 2 is an operational flow chart of the transmission of a payment transaction file from a pay and display machine to a centralization server, and

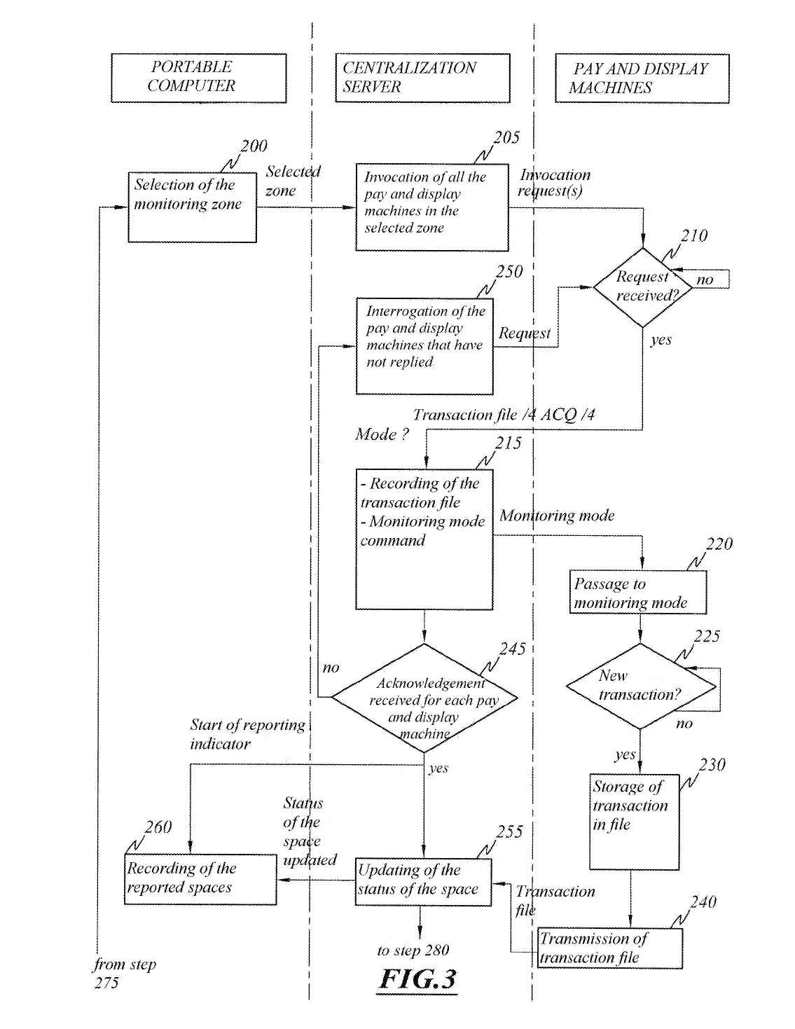

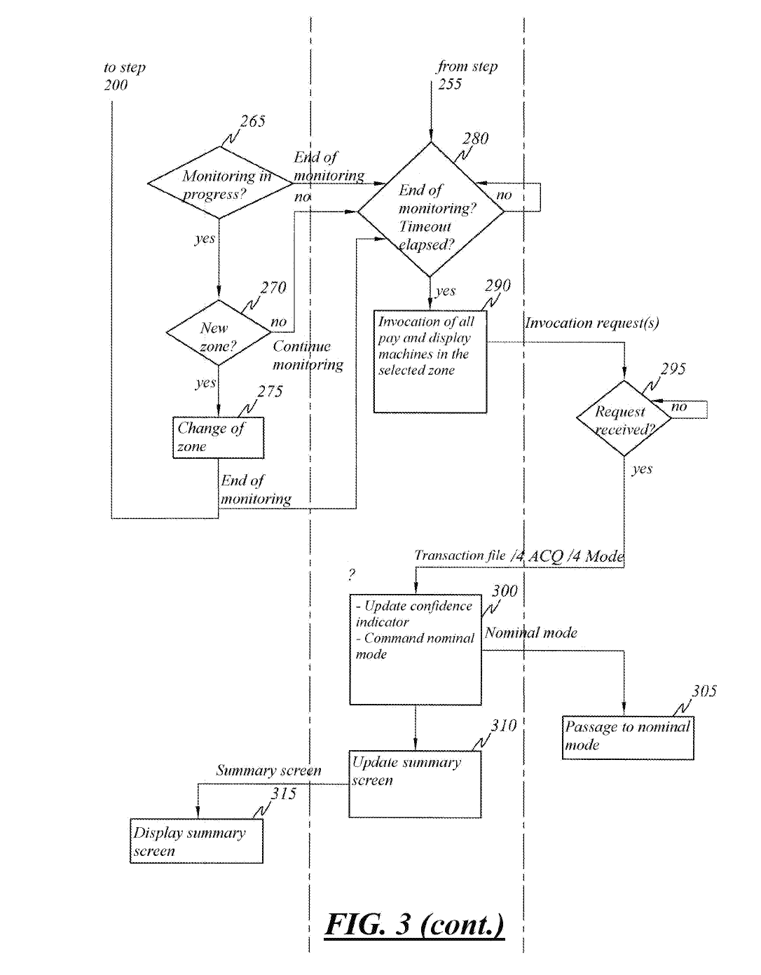

FIG. 3 is an operational flow chart of a procedure for monitoring the payment of parking fees.

In FIG. 1, the centralized parking payment system 2 comprises a payment centralization server 4, a plurality of pay and display machines 6 and a portable computer 8 used by an operator 10. The portable computer 8 is preferably a miniature computer and constitutes a personal assistant known by the acronym PDA (person digital assistant). Each pay and display machine 6 communicates with the centralization server 4 via a first data connection 12, and the portable computer 8 communicates with the centralization server 4 via a second, wireless connection 14. The first connection 12 is, for example, a radio connection.

An external server 16 communicates with the centralization server 4 via a third connection 18. The external server 16 is, for example, a banking server for authorizing payment transactions in the case of payment by bank card from a pay and display machine. The third connection 18 is, for example, a wired connection.

Each pay and display machine 6 is capable of communicating with the external server 16 via the first, wireless connection 12 and the centralization server 4.

The centralization server 4 comprises an information processing unit 20, a memory 22, a data transmitter/receiver 24, and display means 26. The centralization server 4 is supplied with power by an alternative power supply system (not shown).

Each pay and display machine 6 comprises an information processing unit 28, a memory 30, a data transmitter/receiver 32, and display means 34. Each pay and display machine 6 also comprises a keypad 36, a card reader 38 and/or a cash acceptor 39. The card reader 38 is capable of reading bank cards, for example cards with a magnetic strip, or smart cards.

Each pay and display machine 6 is supplied with power by an autonomous battery 40, that is to say a battery that is not recharged from a supply system. Each battery 40 is connected to solar panels 42 for recharging by solar energy.

Each pay and display machine 6 covers a payment zone 44 geographically. A plurality of parking spaces (not shown) is located in each payment zone 44. The payment zones 44 can partially overlap.

A parking fee payment monitoring zone 46 includes a plurality of parking spaces, without there being any relationship with the payment zones 44.

The PDA 8 comprises an information processing unit, a memory, a data transmitter/receiver, and display means (not shown).

Each pay and display machine 6, by virtue of its information processing unit 28, executes a computer programme which manages its own operation. The programme especially allows payment to be made by means of a bank card and/or cash introduced into the cash acceptor, and the production of transaction information which includes the number of the parking space and the parking time for which payment has been made. These data are stored in a payment transaction file in the memory 30 under the control of the processing unit 28.

The programme contained in the pay and display machine also manages transmissions from and to the servers 4 and 16.

Each pay and display machine 6 is in a nominal mode or alternatively in a monitoring mode, the two modes being mutually exclusive.

In nominal mode, the pay and display machine 6 stores, for each new payment transaction, the corresponding payment data in its transaction file without systematically sending it to the centralization server 4. The pay and display machine 6 only transmits its transaction file when one of the transmission conditions, apart from the simple creation of payment data, is verified. The nominal mode is intended to reduce energy consumption by limiting the number of transaction file transmissions.

In monitoring mode, the pay and display machine 6 sends its transaction file each time a new payment transaction is received. The pay and display machine 6 enters monitoring mode only at the request of the operator 10. This mode is intended to ensure that the information necessary for monitoring parking fee payments is always available, when desired by the operator 10. As soon as the operator 10 has finished monitoring the payment of parking fees, the pay and display machine 6 returns to nominal mode in order to reduce its energy consumption.

The server 4 also operates under the control of software which ensures that the payment transaction files are received from each pay and display machine and which, on request, transmits payment information to the operator's portable computer 8.

The PDA 8 also operates under the control of a computer programme which ensures receipt of the information acquired by the operator 10, the transmission to the centralization server 4 of the selected monitoring zone 46, and the processing and display of information received from the centralization server 4.

The operation of a procedure for transmitting a payment transaction file from the pay and display machine 6 to the centralization server 4 will now be described with the aid of FIG. 2. The transmission procedure comprises a series of steps and is executed under the control of the programme contained in the pay and display machine 6.

In step 100, the transaction file, which is stored in the memory 30 of the pay and display machine, is empty. A variable E is fixed at zero. The processing unit 28 then passes from step 100 to step 105.

In step 105, the processing unit 28 checks whether the centralization server 4 has sent it a request, or whether it has established a connection with the external server 16. If one of those two conditions is verified, the unit 28 passes to step 140; otherwise, it passes to step 110.

In step 110, the processing unit 28 checks whether the payment receiving means 38, 39 have received a new payment transaction for a parking space. If no new transaction has been detected, the unit 28 passes to step 115. Otherwise, payment data are created by the processing unit 28 and are stored in the memory 30. The unit 28 then passes to step 120.

In step 115, the processing unit 28 tests whether the transaction file contains payment data for at least one transaction. If the transaction file is empty, the unit 28 returns to step 105. Otherwise, it passes to step 135.

In step 120, the processing unit 28 tests whether the transaction received by the pay and display machine 6 relates to a space situated outside its payment zone 44. The processing unit 28 also checks whether it is in parking fee payment monitoring mode. If one of those two conditions is verified, the unit 28 passes to step 125. Otherwise, it passes to step 130.

In step 125, the variable E is fixed at 1, then the processing unit 28 passes to step 130.

In step 130, the processing unit 28 records the payment data for the current transaction in the transaction file stored in the memory 30. When recording of the data is complete, the processing unit 28 passes to step 135.

In step 135, the processing unit 28 tests whether the payment data for the oldest transaction have been present in the transaction file for a time greater than a predetermined value Time_X. Accordingly, the unit 28 ensures that the payment data are not stored in the transaction file for a time that exceeds a predetermined and parameterizable value. The processing unit 28 also tests whether the variable E is equal to 1. If one of those two conditions is verified, the unit 28 passes to step 140. Otherwise, it returns to step 105.

In step 140, the transaction file is transmitted by the transmitter/receiver 32 of the pay and display machine to the transmitter/receiver 24 of the centralization server. At the end of the transmission, the processing unit 28 passes to step 145.

In step 145, the processing unit 28 deletes the contents of the transaction file at the corresponding address in the memory 30. After deleting the transaction file, the processing unit 28 returns to the initial step 100.

The operation of a procedure for monitoring the payment of parking fees will now be described with the aid of FIG. 3. The monitoring procedure is executed, according to the steps in question, by the centralization server 4, the pay and display machine 6 and the portable computer 8 used by the operator 10.

In the first step 200, the operator 10 selects on the PDA 8 the monitoring zone 46 that he has chosen. The selected monitoring zone 46 is then transmitted by the PDA 8 to the centralization server 4 for processing in step 205.

In step 205, the processing unit 20 of the centralization server sends an invocation request to each pay and display machine 6 of the selected monitoring zone 46. The monitoring procedure continues in step 210.

In step 210, when the invocation request has been received by the transmitter/receiver 32, the pay and display machine 6 sends to the centralization server 4, by way of its transmitter/receiver 32, its transaction file, an acknowledgement that the invocation request has been received, and a request for indication of its next mode. This information is processed in step 215.

In step 215, the processing unit 20 of the centralization server records the transaction file received from the pay and display machine 6 in its memory 22. In response to the request for indication of the mode in which the pay and display machine 6 must be, the processing unit 20 sends to the corresponding pay and display machine 6 a command for passage into monitoring mode.

In step 220, when the transmitter/receiver 32 of the pay and display machine has received the command for passage into monitoring mode transmitted in step 215, the processing unit 28 passes from nominal mode to monitoring mode. The unit 28 then passes from step 220 to step 225.

In step 225, the processing unit 28 checks whether the payment receiving means 38, 39 have received a new payment for a parking space. If a new payment transaction has been carried out, the processing unit 28 then passes to step 230. Otherwise, the unit 28 loops back to step 225, optionally after a timeout, until a new payment transaction is received.

In step 230, the payment data for the new transaction are recorded by the processing unit 28 in the transaction file stored in the memory 30 of the pay and display machine. The pay and display machine 6 then passes to step 240.

In step 240, the transaction file is sent by the transmitter/receiver 32 of the pay and display machine to the transmitter/receiver 24 of the centralization server. The transmitted transaction file is taken into consideration by the processing unit 20 in step 255.

In step 245, the processing unit 20 of the centralization server tests whether each pay and display machine 6 located in the selected monitoring zone 46 has sent an acknowledgement for the invocation request. If the acknowledgement of the request has not been received for at least one pay and display machine 6, the processing unit 20 passes to step 250.

If an acknowledgement has been received for each pay and display machine 6 located in the monitoring zone 46, the processing unit 20 of the centralization server sends to the PDA 8 a start of reporting indicator. The processing unit 20 then passes to step 255.

In step 250, the processing unit 20 sends a new invocation to the pay and display machines 6 that have not replied to the first invocation. The procedure then returns to step 210.

In step 255, the processing unit 20 updates the status of the payment spaces located in the payment zone 44 for each pay and display machine 6 that has sent its transaction file in step 240. The unit 20 sends the updated status of each space to the PDA 8, and then passes to step 280. The statuses sent by the server 4 are processed by the PDA in step 260.

In step 260, the operator 10 determines, in dependence on the updated statuses, the motor vehicles for which a parking fee has not been paid. The operator 10 prepares a report for each offending motor vehicle and records the numbers of the spaces in question in his PDA 8.

In step 265, the processing unit of the computer 8 tests whether the operator 10 has finished monitoring the payment of parking fees. If the operator 10 wishes, tacitly, to continue monitoring, the processing unit passes to step 270. If the operator 10 has finished monitoring, the processing unit of the PDA 8 interrupts step 260 and sends to the centralization server 4 an end of monitoring command, which is processed in step 280 by the unit 20.

In step 270, the processing unit of the PDA 8 tests whether the operator 10 has requested a change of monitoring zone 46. In that case, the processing unit of the computer 8 passes to step 275. Otherwise, the processing unit of the computer 8 sends to the centralization server 4 a continue monitoring message, which will be processed in step 280 by the processing unit 20, and step 260 continues.

In step 275, the computer 8 processes the change of monitoring zone 46 and in the first instance sends to the centralization server 4 the end of monitoring command, which will be taken into consideration in step 280 by the processing unit 20. In the second instance, the processing unit of the PDA 8 passes from step 280 to the initial step 200, in order to take into account a new monitoring zone 46 chosen by the operator 10.

In step 280, the processing unit 20 checks whether the portable computer 8 has sent the end of monitoring command. If not, it tests whether a parameterizable timeout has elapsed since receipt of the monitoring zone 46 selected in step 205. If the end of monitoring command has been received, or if the timeout has elapsed, the unit 20 passes to step 290, in order to discontinue the monitoring mode. Otherwise, the processing unit 20 loops back to step 280 and waits to receive an end of monitoring command or waits for the end of the timeout.

In step 290, the processing unit 20 sends an invocation request to all the pay and display machines 6 located in the selected monitoring zone 46. This request is processed in step 295 by the processing unit 28 of each pay and display machine 6.

In step 295, each processing unit 28 of the pay and display machines located in the monitoring zone 46 checks whether an invocation request has been received by the centralization server 4. If a request has been received, the processing unit 28 sends its transaction file to the centralization server 4 and requests the chosen new mode. This new message is processed in step 300 by the processing unit 20. Otherwise, the processing unit 28 loops back to step 295 and waits to receive an invocation request.

In step 300, the processing unit 20 records the transaction file received from each pay and display machine 6 and updates a confidence indicator, which represents the number of pay and display machines 6 that have acknowledged the invocation request in dependence on the number of pay and display machines 6 in the selected monitoring zone 46. The processing unit 20 then sends a command for passage to nominal mode to each pay and display machine 6 that has acknowledged the invocation request. The command for passage to nominal mode is processed in step 305 for each processing unit 28 in question. The processing unit 20 passes from step 300 to step 310.

In step 305, the processing unit 28 passes into nominal mode after receiving the command for passage to nominal mode sent by the centralization server 4.

In step 310, the processing unit 20 creates a summary screen of the monitoring of the payment of parking fees. The processing unit 20 sends to the portable computer 8 a message containing the summary screen, which is processed in step 315.

In step 315, the processing unit of the PDA 8 receives the message containing the summary screen and then displays it on the screen of the PDA 8.

Accordingly, the method according to the invention allows the energy consumption for each pay and display machine 6 to be reduced by limiting the number of messages sent by each pay and display machine 6 that is in nominal mode.

The method also makes it possible to ensure that the information necessary for monitoring the payment of parking fees is always available because, in that case, each pay and display machine 6 managing parking spaces belonging to the selected monitoring zone 46 passes into a monitoring mode, in which it sends its transaction file as soon as it receives a new payment transaction.

It is more advantageous for the first connection 12 to be a radio connection, which allows the pay and display machine 6 to be sited in a location without a wired telecommunication system.

However, by way of variation, it is provided that the first data connection 12 is a wired connection.

1. Method of managing a centralized parking payment system (2), said system (2) comprising at least one pay and display machine (6) and a payment centralization server (4), the or each pay and display machine (6) permitting payment for parking spaces situated in a corresponding payment zone (44) and being capable of creating payment data for the parking spaces and of recording that data in a payment transactions file, and each pay and display machine (6) communicating via a first connection (12) with the centralization server (4), characterized in that it comprises a nominal operating mode in which the or each pay and display machine (6) transmits the transaction file only when one of the transmission conditions, apart from the simple creation of payment data, is verified, in order to reduce its energy consumption, and in that, in nominal operating mode, the ratio between the number of transaction files transmitted and the number of payment transactions is strictly less than 1.

2. Method according to claim 1, characterized in that exchanges of transaction files between the or each pay and display machine (6) and the centralization server (4) are at least partially aperiodic.

3. Method according to claim 1, characterized in that the transmission conditions include the receipt of a request from the centralization server (4).

4. Method according to claim 3, characterized in that the or each pay and display machine (6) is always in either nominal mode or parking fee payment monitoring mode, said monitoring mode being activated upon a request from an operator (10), and, in monitoring mode, the transaction file is transmitted to the centralization server (4) in dependence on the creation of payment data.

5. Method according to claim 4, characterized in that it comprises steps in which:
an operator formulates a request for monitoring of the payment of parking fees in a monitoring zone (46),
each pay and display machine (6) that is located in the monitoring zone (46) and has received the monitoring request from the centralization server (4) sends its transaction file to the centralization server (4),
on a command from the centralization server (4), each pay and display machine (6) that has transmitted its transaction file passes into monitoring mode.

6. Method according to claim 1, characterized in that the transmission conditions include secondary conditions which are as follows:
the pay and display machine (6) is connected to a server (16) external to the payment system (2),
the pay and display machine (6) receives a payment transaction for a space outside its payment zone (44), and
at least one payment transaction has been contained in the transaction file for a time that exceeds a predetermined time (Time_X).

7. Centralized parking payment system (2), of the type comprising at least one pay and display machine (6), a payment centralization server (4) and means (24, 32) for exchanging data via a first connection (12) between the centralization server (4) and the or each pay and display machine (6), the or each pay and display machine (6) comprising means (38, 39) for receiving a payment for parking spaces in a corresponding payment zone (44), means (28) for creating payment data for the parking spaces, and means (28, 30) for recording said payment data in a payment transactions file, characterized in that the or each pay and display machine (6) is capable, in a nominal operating mode, of transmitting a message only when one of the transmission conditions, apart from the simple creation of payment data, is verified, in order to reduce its energy consumption, and in that, in nominal operating mode, the ratio between the number of transaction files transmitted and the number of payment transactions is strictly less than 1.

8. System (2) according to claim 7, characterized in that each pay and display machine (6) is supplied with power by an autonomous battery (40).

9. System (2) according to claim 8, characterized in that each pay and display machine (6) comprises means (42) for recharging the autonomous battery (40) by solar energy.

10. System (2) according to claim 7, characterized in that each pay and display machine (6) is capable of communicating with an external server (16) via a first connection (12) and the centralization server (4), said external server (16) preferably being a banking server.

11. System (2) according to claim 7, characterized in that it comprises a portable computer (8) which is used by an operator (10) and communicates with the centralization server (4) via a second connection (14).

12. System (2) according to claim 8, characterized in that each pay and display machine (6) is capable of communicating with an external server (16) via a first connection (12) and the centralization server (4), said external server (16) preferably being a banking server.

13. System (2) according to claim 8, characterized in that it comprises a portable computer (8) which is used by an operator (10) and communicates with the centralization server (4) via a second connection (14).

13. Method according to claim 2, characterized in that the transmission conditions include the receipt of a request from the centralization server (4).

14. Method according to claim 2, characterized in that the transmission conditions include secondary conditions which are as follows:
the pay and display machine (6) is connected to a server (16) external to the payment system (2),
the pay and display machine (6) receives a payment transaction for a space outside its payment zone (44), and
at least one payment transaction has been contained in the transaction file for a time that exceeds a predetermined time (Time_X).
